(19) United States
(12) Patent Application Publication
(10) Pub. No.: US 2024/0029412 A1
(43) Pub. Date: Jan. 25, 2024

(54) MODEL TRAINING METHOD AND MODEL TRAINING SYSTEM

(71) Applicant: Pegatron Corporation, Taipei City (TW)

(72) Inventor: Peng-Hua Huang, Taipei City (TW)

(73) Assignee: Pegatron Corporation, Taipei City (TW)

(21) Appl. No.: 18/297,251

(22) Filed: Apr. 7, 2023

(30) Foreign Application Priority Data
Jul. 19, 2022 (TW) 111127008

(51) Int. Cl. G06V 10/774; G06T 7/194; G06T 5/50

(52) U.S. Cl. CPC G06V 10/774; G06T 7/194; G06T 5/50; G06T 2207/20081; G06T 2207/20104; G06T 2207/20212

(57) ABSTRACT

A model training method and a model training system are disclosed. The method includes the following. A first image with an on-image mark is obtained. In response to the on-image mark of the first image, an automatic background replacement is performed on the first image to generate a second image. A background image of the second image is different from a background image of the first image. Training data is generated according to the second image. An image identification model is trained by using the training data.

### CROSS-REFERENCE TO RELATED APPLICATION

This application claims the priority benefit of Taiwan application serial no. 111127008, filed on Jul. 19, 2022. The entirety of the above-mentioned patent application is hereby incorporated by reference herein and made a part of this specification.

### BACKGROUND

### Technology Field

The invention relates to a model training method and a model training system.

### Description of Related Art

In a current deep learning platform, if a background synthesized image is added as training data for a model during training to expand a data base of the training data, it is often necessary to use additional image processing software to remove a background of the image and perform foreground and background synthesis to generate a synthesized image. Then, the synthesized image is uploaded to an online training platform to train the model. However, in practice, the way in which a user manually performs off-line synthesis and uploads the synthesized image to the online training platform is seriously inefficient.

### SUMMARY

The invention relates to a model training method and a model training system, which may improve the aforementioned issue.

An embodiment of the invention provides a model training method configured to train an image identification model, and the model training method includes the following. A first image is obtained. It is determined whether the first image has an on-image mark. If the first image has the on-image mark, an automatic background replacement is performed on the first image to generate a second image in response to the on-image mark of the first image. A background image of the second image is different from a background image of the first image. Training data is generated according to the second image. The image identification model is trained by using the training data.

An embodiment of the invention further provides a model training system including a storage circuit and a processor. The storage circuit is configured to store an image identification model. The processor is coupled to the storage circuit. The processor is configured to obtain a first image; determine whether the first image has an on-image mark; if the first image has the on-image mark, perform an automatic background replacement on the first image to generate a second image in response to the on-image mark of the first image, in which a background image of the second image is different from a background image of the first image; generate training data according to the second image; and train the image identification model by using the training data.

Based on the above, the model training method and model training system provided by the invention may perform the automatic background replacement on the image and generate corresponding training data, and use the training data to train the image identification model. In this way, the training efficiency of the image identification model is effectively improved.

### BRIEF DESCRIPTION OF THE DRAWINGS

FIG. 1 is a schematic diagram of a model training system according to an embodiment of the invention.

FIG. 2 is a schematic diagram of an operation flow of a model training system according to an embodiment of the invention.

FIG. 3 is a schematic diagram of generating a second image according to a first image according to an embodiment of the invention.

FIG. 4 is a schematic diagram of generating a second image according to a first image according to an embodiment of the invention.

FIG. 5 is a flowchart of a model training method according to an embodiment of the invention.

FIG. 6 is a flowchart of a model training method according to an embodiment of the invention.

### DESCRIPTION OF THE EMBODIMENTS

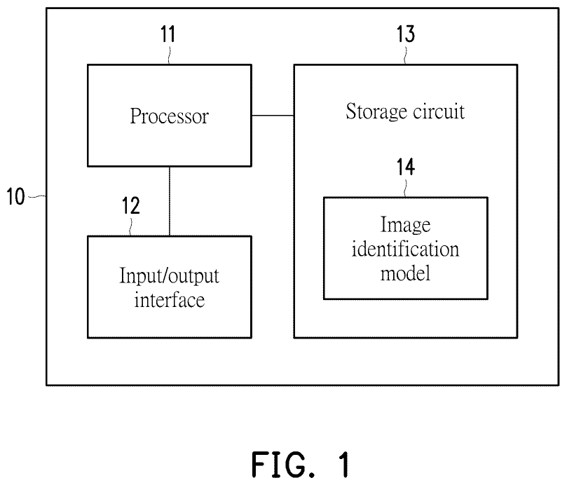

FIG. 1 is a schematic diagram of a model training system according to an embodiment of the invention.

Referring to FIG. 1, a model training system 10 may be installed or implemented in various computer systems such as smart phones, tablet computers, notebook computers, desktop computers, servers or game machines, and the types of the computer system are not limited to this.

The model training system 10 may include a processor 11, an input/output (IO) interface 12 and a storage circuit 13. The processor 11 is in charge of overall or a part of operations of the model training system 10. For example, the processor 11 may include a central processing unit (CPU) or other programmable general-purpose or special-purpose microprocessors, digital signal processors (DSP), programmable controllers, application specific integrated circuits (ASIC), programmable logic devices (PLD) or other similar devices or a combination of these devices.

The input/output interface 12 is coupled to the processor 11. The input/output interface 12 is used for receiving an input signal and/or transmitting an output signal. For example, the input/output interface 12 may include various input/output devices such as a mouse, a keyboard, a screen, a network interface card, a speaker, or a microphone, and the type of the input/output interface 12 is not limited thereto.

The storage circuit 13 is coupled to the processor 11. The storage circuit 13 is used for storing data. For example, the storage circuit 13 may include a volatile storage circuit and a non-volatile storage circuit. The volatile storage circuit is used for storing data in a volatile manner. For example, the volatile storage circuit may include a random access memory (RAM) or a similar volatile storage medium. The non-volatile storage circuit is used for storing data in a non-volatile manner. For example, the non-volatile storage circuit may include a read only memory (ROM), a solid state disk (SSD), a conventional hard disk drive (HDD) or a similar non-volatile storage medium.

The storage circuit 13 stores an image identification model 14. The image identification model 14 may be used to identify objects in an image (also referred to as a target image). For example, the image identification model 14 may include a neural network model and/or a deep learning model. The neural network model and/or the deep learning model may use convolutional neural networks (CNN) or similar neural networks to perform image identification. In addition, by training the image identification model 14, identification efficiency of the image identification model 14 to identify the target object may be improved.

The processor 11 may use the training data to train the image identification model 14. For example, the training data may include a plurality of training images. The processor 11 may take a certain training image as a target image for inputting to the image identification model 14. The image identification model 14 may identify a target object in the target image through a built-in neural network model and/or deep learning model. For example, the image identification model 14 may identify the target object in the target image. A result of the identification of the target object may reflect characteristics of the target object in the target image as perceived by the image identification model 14. After the identification of the target object is completed, the processor 11 may compare an identification result of the target object obtained by the image identification model 14 with verification data corresponding to the target image to obtain a comparison result. The comparison result may reflect the identification accuracy of the target object achieved by the image identification model 14. The processor 11 may adjust at least some parameters (such as a weight value) of the image identification model 14 according to the comparison result, so as to improve the identification efficiency of the image identification model 14 regarding the target object. By using a large number of training images containing the target object to train the image identification model 14, the identification efficiency of the image identification model 14 regarding the target object may be gradually improved. In addition, in an embodiment, the identification result of the target image generated by the image identification model 14 may also include identifying a type of the target object (for example, a dog) in the target image, which is not limited by the invention.

Generally, the more training images and the more diversity with the same type of target object are used to train the image identification model 14, the higher the identification efficiency of the image identification model 14 for this type of target object may achieve. For example, when it is desired to improve the identification ability of the image identification model 14 to identify “dog” in the target image, a large number of images with “dog” may be used to train the image identification model 14. In particular, the broader diversity or the bigger difference these images have (for example, there is the same dog in multiple images, and the backgrounds in these images are different), the better the training efficiency is achieved when these images are used to train the image identification model 14. Therefore, the embodiment of the invention automatically generates the target image with different background images through an automatic background replacement. In this way, the training efficiency of the image identification model may be effectively improved.

In an embodiment, the processor 11 may obtain an image (also referred to as a first image) with an on-image mark. In response to the on-image mark of the first image, the processor 11 may perform the automatic background replacement on the first image to generate another image (also referred to as a second image). In particular, a background image of the second image is different from a background image of the first image. For example, by automatically performing background replacement on the first image, more second images with different background images may be generated while the target object of the first image is yet kept in the second image. Then, the processor 11 may generate training data according to the second image. For example, a training image in the training data may include the second image. Then, the processor 11 may use the training data to train the image identification model 14, so as to effectively improve the identification efficiency of the image identification model 14 regarding the target object.

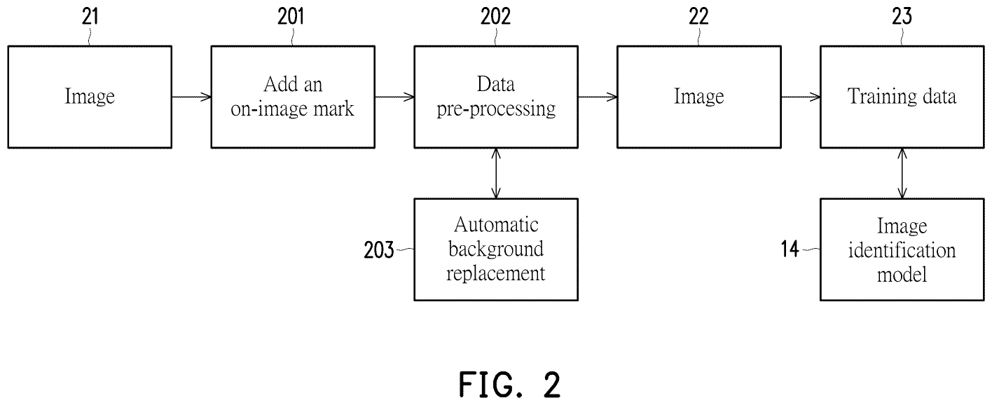

FIG. 2 is a schematic diagram of an operation flow of a model training system according to an embodiment of the invention.

Referring to FIG. 1 and FIG. 2, the processor 11 may obtain an image 21 (i.e., the first image). In the embodiment of the invention, the image 21 may be uploaded to the model training system 10 by a user through the input/output interface 12. The processor 11 may receive a user operation corresponding to the image 21. Then, the processor 11 may display an on-image mark 201 to the image 21. In detail, the user operation may include marking a foreground region on the image 21. For example, the foreground region may include the target object in the image 21. Then, the processor 11 may generate the on-image mark 201 corresponding to the image 21 according to the user operation (or the foreground region). For example, the on-image mark 201 may reflect a coverage range of the foreground region in the image 21.

After displaying the on-image mark 201, the processor 11 may perform data pre-processing 202 on the image 21 with the on-image mark 201. For example, the data pre-processing 202 may include a step of performing a pre-set image processing operation such as colour adjustment, brightness adjustment, and/or resolution adjustment on the image 21.

Particularly, during the process of data pre-processing 202, the processor 11 may further perform an automatic background replacement 203 on the image 21 with the on-image mark 201 to generate an image 22 (i.e., the second image). For example, in the automatic background replacement 203, the processor 11 may determine a background region in the image 21 according to the on-image mark 201. In particular, compared to the foreground region, the background region in the image 21 does not include the target object in the image 21. For example, the processor 11 may determine that the remaining image region in the image 21 that does not belong to the foreground region or is not within the coverage of the foreground region is the background region, according to the on-image mark 201. Then, in the automatic background replacement 203, the processor 11 may use a candidate pattern (which is also referred as a candidate background image) to replace a default pattern (which is also referred as a default background image) in the background region to generate the image 22. In this way, the generated image 22 may include both the original image in the foreground region of the image 21 and the replaced background image in the background region. In an embodiment, the on-image mark 201 may be used to trigger the automatic background replacement 203.

After generating the image 22, the processor 11 may generate the training data 23 according to the image 22. For example, the training data 23 may include the image 22. Then, the processor 11 may use the training data 23 to train the image identification model 14, so as to improve the identification efficiency of the image identification model 14 regarding the target object in the image 21. It should be noted that the related operation of using the training data to train the image identification model 14 have been described in detail above and it also belongs to the prior art of the related field, so that detail thereof is not repeated here.

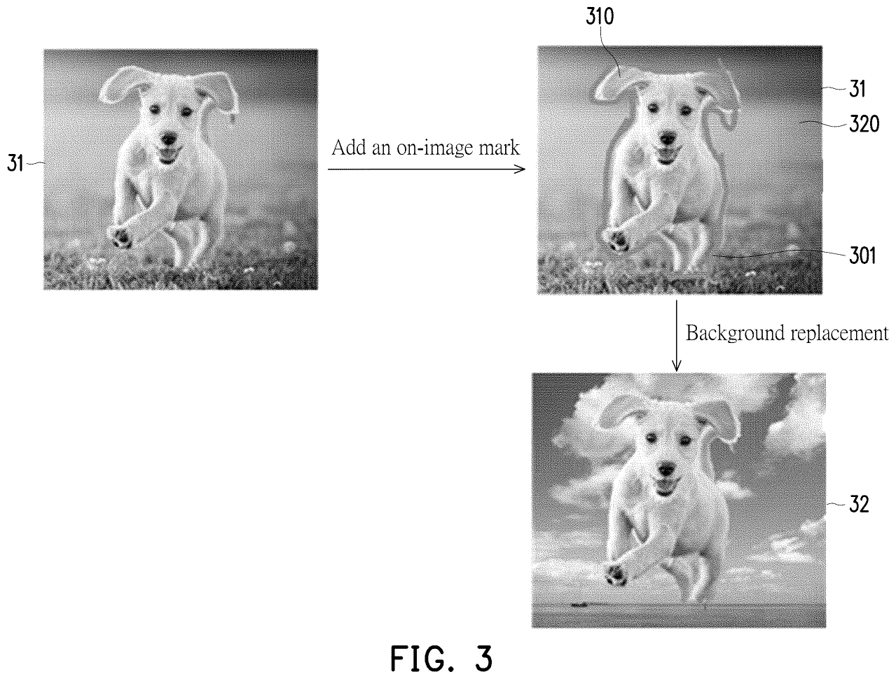

FIG. 3 is a schematic diagram of generating a second image according to a first image according to an embodiment of the invention.

Referring to FIG. 3, it is assumed that the first image includes an image 31. An on-image mark 301 may be added to the image 31 by a user operation. For example, the user operation may include that the user circles the target object (such as a dog) in the image 31 through an input tool such as a finger, a mouse, or a stylus pen, so as to generate the on-image mark 301. The on-image mark 301 may be used to define or distinguish different regions 310 and 320 in the image 31. For example, the target object (such as a dog) in the image 31 is located in the region 310 but is not in the region 320, so the regions 310 and 320 may be regarded as a foreground region and a background region, respectively, in the image 31.

Then, the automatic background replacement of the image 31 may be automatically performed according to the on-image mark 301 to generate an image 32. For example, in the automatic background replacement of the image 31, a pattern (i.e., a background image) in the region 320 is replaced with a different background image. However, in the automatic background replacement of the image 31, the pattern containing the target object in the region 310 is not changed (i.e., maintained).

It should be noted that in the embodiment of FIG. 2, by replacing the default background image in the background region with different candidate background images, more images 22 may be generated. In particular, the background images in the generated images 22 are different. In this way, the diversity of the training data 23 may be effectively increased while the target object in the original image (i.e., the image 21) is still kept, thereby improving the subsequent training efficiency of the image identification module 14.

In the embodiment of FIG. 3, the on-image mark 301 may be produced by the user to mark along an edge of the target object (such as a dog) in the image 31, so as to generate a coverage range of a foreground region corresponding to a contour of the target object (i.e., the region 310). However, in an embodiment, the on-image mark may also be in other shapes (such as polygons, circles, or ellipses) defined by the user to mark the coverage range of the foreground region (or the background region) in the first image, which is not limited by the invention.

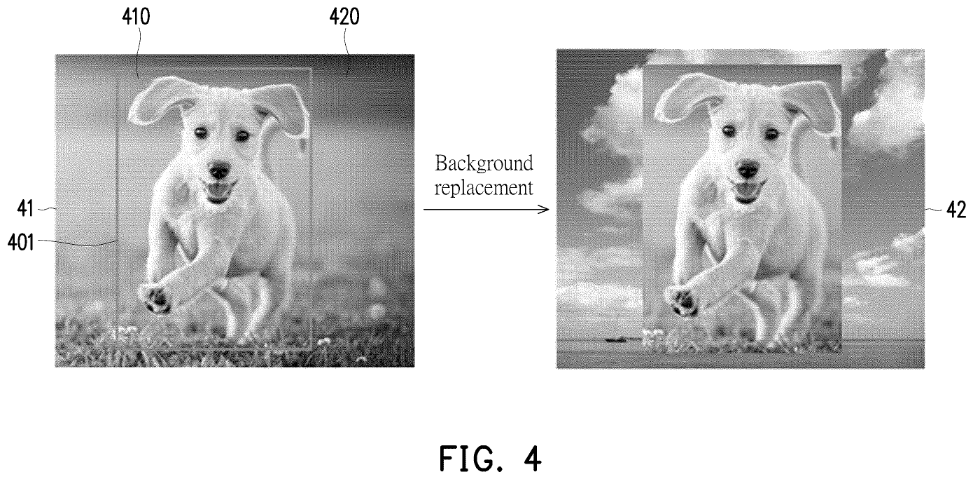

FIG. 4 is a schematic diagram of generating a second image according to a first image according to an embodiment of the invention.

Referring to FIG. 4, it is assumed that the first image includes an image 41. An on-image mark 401 may be added to the image 41 according to the user operation. In particular, compared with the embodiment of FIG. 3, the shape of the on-image mark 401 in the image 41 is a rectangle, and the shape of the on-image mark 401 is not limited thereto. The on-image mark 401 may be used to define or distinguish different regions 410 (i.e., the foreground region) and 420 (i.e., the background region) in the image 41. Then, the automatic background replacement of the image 41 may be automatically performed according to the on-image mark 401 to generate an image 42. For example, in the automatic background replacement of the image 41, a pattern in the region 420 (i.e., the background image) is replaced with a different background image.

In an embodiment, the user operation may also include a normal mark on the first image instead of the on-image mark. For example, the normal mark may be used to describe a type of target object in the first image and/or a location of the target object in the first image. However, compared to the on-image mark that may be used to trigger the automatic background replacement, the normal mark corresponding to the first image does not trigger the automatic background replacement of the first image.

In an embodiment, if the first image does not have the on-image mark (for example, only has a normal mark, or without any mark), the processor 11 may directly generate training data according to the first image. Or, according to another point of view, in response to the first image without the on-image mark, the processor 11 may not perform (or skip) the automatic background replacement on the first image and not generate the second image. In this way, by identifying whether the first image has the on-image mark, the processor 11 may automatically determine whether the user currently wants to perform automatic background replacement on the first image, thereby effectively improving the convenience of operation.

In an embodiment, the normal mark may be added to the first image alone, or added to the first image together with the on-image mark. Namely, the user operation performed on the first image may indicate the adding of a normal mark or the adding of the normal mark and the on-image mark to the first image both.

In an embodiment, after the training data is generated according to the first image or the second image, the normal mark corresponding to the training data may be used to verify the identification result of the image identification model 14. For example, it is assumed that certain training data is generated according to the first image or the second image, after the training data is input into the image identification model 14 as the target image, the image identification model 14 may generate an identification result that determines the target object in the target image as a “dog”. Then, it is assumed that the normal mark corresponding to the target image is also a “dog”, the processor 11 may determine that the identification result of the image identification model 14 regarding the target image is correct by comparing the identification result of the image identification model 14 with the target image marked by the normal mark. Conversely, if the image identification model 14 determines that the target object in the target image is a “pig”, the processor 11 may determine that the identification result of the image identification model 14 regarding the target image is incorrect by comparing the identification result of the image identification model 14 with the target image marked by the normal mark. It should be noted that related operations of the normal mark to verify the identification result of the image identification model have been described in detail above and belong to the prior art of the related field, so that details are not repeated here.

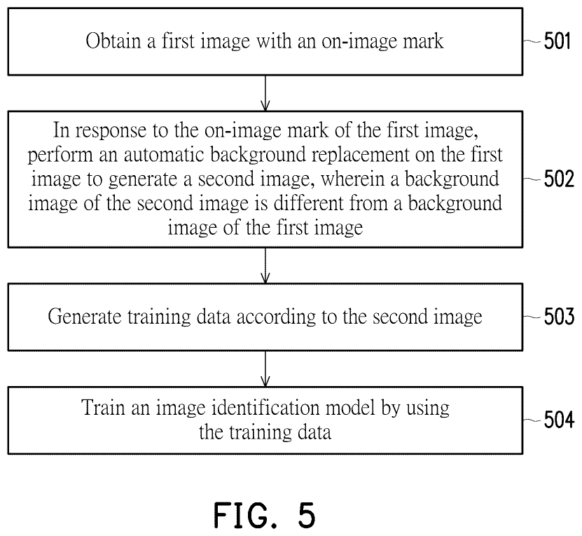

FIG. 5 is a flowchart of a model training method according to an embodiment of the invention.

Referring to FIG. 5, in step 501, a first image with an on-image mark is obtained. In step 502, in response to the on-image mark of the first image, the automatic background replacement is performed on the first image to generate a second image, where a background image of the second image is different from that of the first image. In step 503, training data is generated according to the second image. In step 504, an image identification model is trained by using the training data.

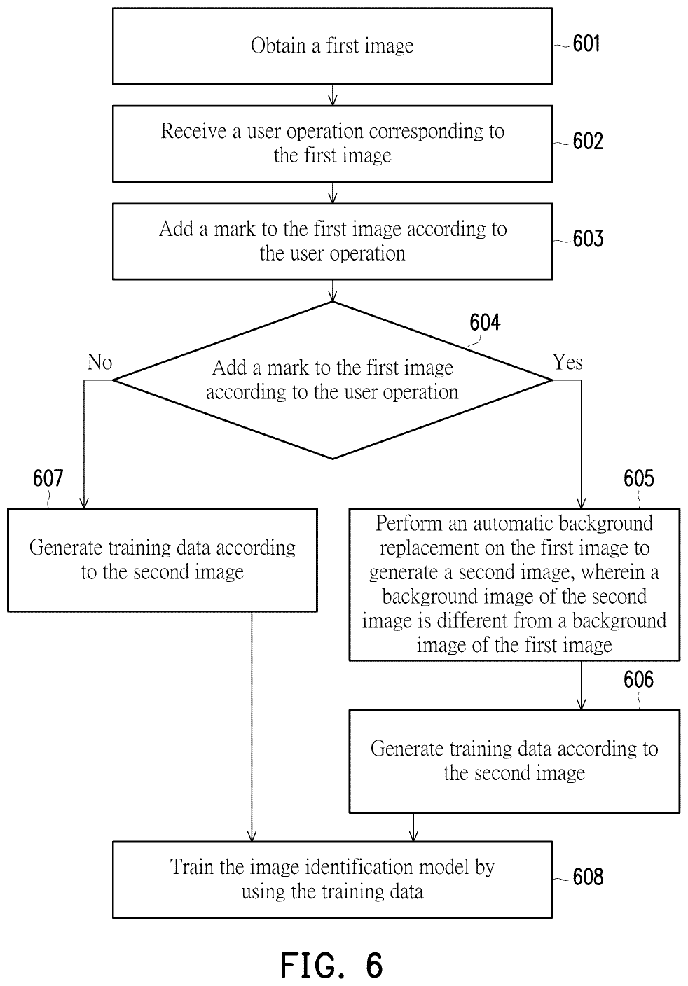

FIG. 6 is a flowchart of a model training method according to an embodiment of the invention.

Referring to FIG. 6, in step 601, a first image is obtained. In step 602, a user operation corresponding to the first image is received. In step 603, a mark is added to the first image according to the user operation. For example, the mark may include a normal mark or a combination of the normal mark and an on-image mark.

In step 604, it is determined whether the first image has an on-image mark. In response to the on-image mark of the first image, in step 605, the automatic background replacement is performed on the first image to generate a second image, where a background image of the second image is different from that of the first image. In step 606, training data is generated according to the second image. Alternatively, in response to the first image without the on-image mark, in step 607, the training data is generated according to the first image. In step 608, an image identification model is trained by using the training data.

However, each step in FIG. 5 and FIG. 6 has been described in detail above, and will not be repeated here. It should be noted that each step in FIG. 5 and FIG. 6 may be implemented as multiple program codes or circuits, which is not limited by the invention. In addition, the methods shown in FIG. 5 and FIG. 6 may be used together with reference of the above exemplary embodiments, or may be used alone, which is not limited by the invention.

In summary, the model training method and model training system provided by the invention may perform the automatic background replacement on the first image and generate corresponding training data, so as to use the training data to train the image identification model. In particular, by identifying or detecting the additionally added on-image mark in the first image, the operation of the automatic background replacement may also be automatically activated to automatically generate the second image with the same target object but with different background images. In this way, the training efficiency of the image identification model may be effectively improved.

It will be apparent to those skilled in the art that various modifications and variations can be made to the disclosed embodiments without departing from the scope or spirit of the invention. In view of the foregoing, it is intended that the invention covers modifications and variations provided they fall within the scope of the following claims and their equivalents.

What is claimed is:

1. A model training method configured to train an image identification model, wherein the model training method comprises:
obtaining a first image;
determining whether the first image has an on-image mark;
if the first image has the on-image mark, performing an automatic background replacement on the first image to generate a second image in response to the on-image mark of the first image, wherein a background image of the second image is different from a background image of the first image;
generating training data according to the second image; and
training the image identification model by using the training data.

2. The model training method according to claim 1, further comprising:
receiving a user operation corresponding to the first image; and
generating the on-image mark corresponding to the first image according to the user operation.

3. The model training method according to claim 2, wherein the user operation comprises marking a foreground region in the first image.

4. The model training method according to claim 1, wherein performing the automatic background replacement on the first image to generate the second image comprises:
determining a background region in the first image according to the on-image mark; and
in the automatic background replacement, replacing a default background image in the background region with a candidate background image to generate the second image.

5. The model training method according to claim 1, further comprising:
generating the training data according to the first image if the first image does not have the on-image mark.

6. A model training system, comprising:
a storage circuit configured to store an image identification model; and
a processor coupled to the storage circuit,
wherein the processor is configured to:
obtain a first image;
determine whether the first image has an on-image mark;
if the first image has the on-image mark, perform an automatic background replacement on the first image to generate a second image in response to the on-image mark of the first image, wherein a background image of the second image is different from a background image of the first image;
generate training data according to the second image; and
train the image identification model by using the training data.

7. The model training system according to claim 6, further comprising:
an input/output interface coupled to the processor and configured to receive a user operation corresponding to the first image,
wherein the processor is further configured to generate the on-image mark corresponding to the first image according to the user operation.

8. The model training system according to claim 7, wherein the user operation comprises marking a foreground region in the first image.

9. The model training system according to claim 6, wherein the operation of the processor performing the automatic background replacement on the first image to generate the second image comprises:
determining a background region in the first image according to the on-image mark; and
in the automatic background replacement, replacing a default background image in the background region with a candidate background image to generate the second image.

10. The model training system according to claim 6, wherein if the first image does not have the on-image mark, the processor is further configured to generate the training data according to the first image.
